(19) United States
(12) Patent Application Publication
(10) Pub. No.: US 2017/0155890 A1
(43) Pub. Date: Jun. 1, 2017

(54) METHOD AND DEVICE FOR STEREOSCOPIC IMAGE DISPLAY PROCESSING

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xuelian HU, Tianjin (CN)

(21) Appl. No.: 15/246,386

(22) Filed: Aug. 24, 2016

Related U.S. Application Data
(63) Continuation of application No. PCT/CN2016/089273, filed on Jul. 7, 2016.

(30) Foreign Application Priority Data
Dec. 1, 2015 (CN) 201510869736.7

(51) Int. Cl. H04N 13/04; G06T 19/00

(52) U.S. Cl. CPC H04N 13/044; H04N 13/0497; G06T 19/006

(57) ABSTRACT

The embodiment of the present disclosure discloses a method and device for stereoscopic image display processing. The method comprises the following steps: establishing a first thread and a second thread; synchronously implementing the first thread and the second thread in image rendering process to generate stereoscopic image data corresponding to scenes, wherein the first thread is used for generating a rendered image, and the second thread is used for drawing the rendered image; playing the stereoscopic image data to display corresponding stereoscopic image data. By adopting the method for stereoscopic image display processing according to the embodiment of the present disclosure, the first thread and the second thread are synchronously implemented, so that stereoscopic image data of different scenes can be rapidly generated, the stereoscopic image rendering efficiency can be improved, real-time rendering can be achieved, and the frame rate of a mobile terminal displayed stereoscopic image can be increased.

### CROSS-REFERENCE TO RELATED APPLICATIONS

The present disclosure is a continuation of International Application No. PCT/CN2016/089273 filed on Jul. 7, 2016, which is based upon and claims priority to Chinese Patent Application No. 201510869736.7, entitled “METHOD AND DEVICE FOR STEREOSCOPIC IMAGE DISPLAY PROCESSING”, filed on Dec. 1, 2015, and the entire contents of all of which are incorporated herein by reference.

### TECHNICAL FIELD

The present disclosure generally relates to the technical field of virtual reality, and in particular to a method for stereoscopic image display processing and a device for stereoscopic image display processing.

### BACKGROUND

Along with rapid development of Virtual Reality VR technology, a Virtual Reality system based on a mobile terminal is also rapidly developed. Stereoscopic vision of eyes plays a significant role in the VR system. Specifically, different images seen by two eyes of a user are respectively generated and displayed on different screens. In the VR system based on the mobile terminal, two image frames with certain aberration, of one same scene can be displayed on a left sub-screen and a right sub-screen on the mobile terminal; after the user wears a pair of special glasses, one eye can only see images with frames of odd numbers, and the other one can only see images with frames of even numbers, and the stereoscopic feeling can be achieved due to differences of the frames of odd numbers and the frames of even numbers, namely, vision differences. Briefly speaking, with the VR system based on the mobile terminal, the user can watch images displayed on the screen of the mobile terminal for left and right eyes with special glasses, and thus stereoscopic images can be formed.

In the VR system based on the mobile terminal, when images of a same scene are drawn, to obtain relatively good image quality, images of left and right eyes shall be rendered in real time and counter-distortion and reverse dispersion calculation is also needed. In the VR system based on the mobile terminal, generally left and right eye image rendering as well as calculation tasks such as counter-distortion and reverse dispersion are implemented in a same thread in a serial manner. In the process of realizing the present disclosure, the inventor finds that because of left and right eye image rendering and complicated and heavy calculation tasks of counter-distortion and reverse dispersion, stereoscopic images cannot be rapidly generated, that is, the frame rate of the mobile terminal in displaying the stereoscopic images is relatively low.

### SUMMARY

The embodiment of the present disclosure aims to solve the technical problems of disclosing a method for stereoscopic image display processing, solving the problem that a mobile terminal is slow in stereoscopic image generation, and increasing the frame rate of a mobile terminal stereoscopic image.

Correspondingly, the embodiment of the present disclosure further provides a device for stereoscopic image display processing so as to ensure realization and application of the method.

According to an embodiment of the present disclosure, there is provided a method for stereoscopic image display processing, including:

establishing a first thread and a second thread;

synchronously implementing the first thread and the second thread in image rendering process to generate stereoscopic image data corresponding to scenes, wherein the first thread is used for generating a rendered image, and the second thread is used for drawing the rendered image;

playing the stereoscopic image data to display corresponding stereoscopic image data.

According to an embodiment of the present disclosure, there is provided an electronic device for stereoscopic image display processing, including:

at least one processor; and a memory communicably connected with the at least one processor for storing instructions executable by the at least one processor, wherein execution of the instructions by the at least one processor causes the at least one processor to:

establish a first thread and a second thread;

synchronously implement the first thread and the second thread in image rendering process to generate stereoscopic image data corresponding to scenes, wherein the first thread is used for generating a rendered image, and the second thread is used for drawing the rendered image;

play the stereoscopic image data to display corresponding stereoscopic image data.

According to an embodiment of the present disclosure, there is provided a computer program, comprising computer readable codes for enabling a mobile terminal to execute the method for stereoscopic image display processing above when the computer readable codes are operated on the mobile terminal.

According to an embodiment of the present disclosure, there is provided a non-transitory computer readable medium storing executable instructions that, when executed by an electronic device, cause the electronic device to: establish a first thread and a second thread; synchronously implement the first thread and the second thread in image rendering process to generate stereoscopic image data corresponding to scenes, wherein the first thread is used for generating a rendered image, and the second thread is used for drawing the rendered image; and play the stereoscopic image data to display corresponding stereoscopic image data.

Compared with the prior art, the embodiment of the present disclosure has the following advantages:

according to the embodiment of the present disclosure, in the image rendering process, stereoscopic image data of various scenes can be rapidly generated by implementing a first thread and a second thread synchronously. Specifically, according to the embodiment of the present disclosure, after a rendered image of a current scene is generated by the first thread, a rendered image of a next scene can be continuously generated by the first thread, meanwhile the rendered image of the current scene can be drawn by the second thread to generate the stereoscopic image data of the current scene, then the stereoscopic image rendering efficiency can be improved, the purpose of real-time rendering can be achieved, and the frame rate of the mobile terminal in displaying a stereoscopic image can be increased.

### BRIEF DESCRIPTION OF THE DRAWINGS

To clearly describe the technical schemes in the embodiments of the present disclosure or in the prior art, figures needing to be used in the description of the embodiments or the prior art are briefly introduced as follows, obviously, the figures described below are some embodiments of the present disclosure, and for a person skilled in the art, other figures can be also obtained according to the figures under the condition that no creative work is made.

FIG. 1 shows the flow chart of steps of the method for stereoscopic image display processing in an embodiment of the present disclosure.

FIG. 2 shows the flow chart of steps of the method for stereoscopic image display processing in an optimal embodiment of the present disclosure.

FIG. 3 shows the schematic diagram of synchronous implementation of first thread and second thread in an embodiment of the present disclosure.

FIG. 4A shows the structure diagram of the device for stereoscopic image display processing in an embodiment of the present disclosure.

FIG. 4B shows the structure diagram of the device for stereoscopic image display processing in an optimal embodiment of the present disclosure.

FIG. 5 schematically shows the block diagram of an electronic device for implementing the method of the present disclosure.

FIG. 6 schematically shows a storage unit for retaining or carrying program codes for realizing the method of the present disclosure.

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by a person skilled in the art under the condition that no creative work is made all belong to the protection scope of the present disclosure.

Aiming at the problems, an embodiment of the present disclosure has the key conception that a first thread and a second thread are synchronously implemented in the image rendering process, and then stereoscopic image data corresponding to scenes can be rapidly generated. The first thread is used for generating a rendered image, and the second thread is used for drawing the rendered image.

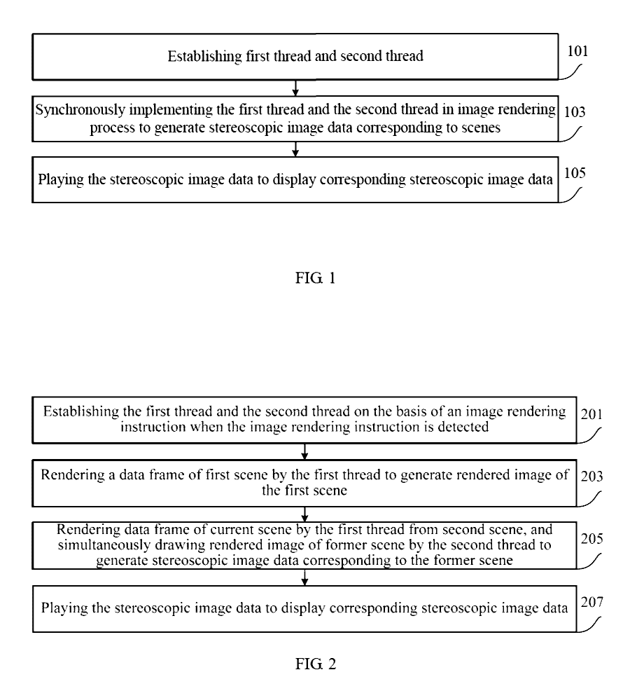

FIG. 1 shows the flow chart of steps of the method for stereoscopic image display processing in an embodiment of the present disclosure, specifically including the following steps.

Step 101, establishing a first thread and a second thread.

In a VR cinema system based on a mobile terminal, before a stereoscopic image is displayed on a display screen, the VR system needs to render data frames (also called as image frames) of different scenes in real time to generate rendered images and implement counter-distortion and reverse dispersion processing on the rendered images, and then relatively good image quality can be achieved. To increase the frame rate of the mobile terminal in displaying the stereoscopic image, the VR system based on the mobile terminal can establish a plurality of threads, and due to synchronous execution of the plurality of threads and sufficient utilization of the time of a Central Processing Unit CPU, the stereoscopic image can be rapidly generated. What needs to be explained is that the mobile terminal refers to computer equipment which can be used in a moving state, such as a smart phone, a notebook computer and a tablet personal computer, which is not restricted in the embodiment of the present disclosure. In the embodiment of the present disclosure, a mobile phone is taken as an example to specifically describe the embodiment of the present disclosure but not being taken as restriction of the embodiment of the present disclosure.

As a specific example of an embodiment of the present disclosure, the VR system based on the mobile phone can establish two threads in advance, calculation of image rendering is carried out by one of the threads, and the thread is marked as a first thread; calculation of counter-distortion and reverse dispersion can be carried out by the other thread which is marked as a second thread.

Optionally, the step 101 can specifically include establishing the first thread and the second thread on the basis of an image rendering instruction when the image rendering instruction is detected.

Step 103, synchronously implementing the first thread and the second thread in image rendering process to generate stereoscopic image data corresponding to the scenes.

Wherein the first thread can be used for generating a rendered image and the second thread can be used for drawing the rendered image. In the image rendering process, the VR system based on a mobile phone can concurrently implement the first thread and the second thread, that is, synchronously implement the first thread and the second thread to generate stereoscopic image data. Specifically, the VR system based on the mobile phone can render data frames of a first scene by the first thread to generate a rendered image of the first scene. From a second scene, the VR system based on the mobile phone can render a current scene by the first thread to generate a rendered image of the current scene, and meanwhile a rendered image of a former scene can be drawn by the second thread to generate corresponding stereoscopic image data of the former scene. By taking the situation that the current scene is taken as the second scene as an example, the VR system based on the mobile phone implement image rendering on the second scene (namely, the current scene) by the first thread to generate the rendered image of the first scene, and at the same time the rendered image of the first scene (namely, the former scene) is drawn by the second thread to generate corresponding stereoscopic image data of the first scene.

Optionally, before the step of synchronously implementing the first thread and the second thread in image rendering process to generate stereoscopic image data corresponding to the scenes, the method for stereoscopic image display processing further includes: rendering data frames of the first scene by the first thread to generate the rendered image of the first scene. Correspondingly, the step of synchronously implementing the first thread and the second thread to generate the stereoscopic image data corresponding to the former scene specifically includes rendering the data frames of the current scene by the first thread from the second scene and drawing the rendered image of the former scene by the second thread to generate stereoscopic image data corresponding to the former scene.

Step 105, playing the stereoscopic image data to display corresponding stereoscopic image data.

Specifically, in the VR system based on the mobile phone, after the stereoscopic image is generated by the second thread, the stereoscopic image data can be played and corresponding stereoscopic image data can be displayed on the display screen, that is, stereoscopic image data corresponding to difference scenes can be displayed on the display screen, equivalently, stereoscopic images corresponding to different scenes can be displayed.

According to the embodiment of the present disclosure, the first thread which is used for generating rendered images and the second thread for drawing the rendered images are established, and image rendering and counter-distortion and reverse dispersion calculation are separated to two independent threads; in the image rendering process, the first thread and the second thread are synchronously implemented to generate stereoscopic image data corresponding to scenes, that is, the first thread and the second thread are concurrently implemented to generate the stereoscopic image data, so that the time for generating the stereoscopic image can be shortened, the stereoscopic image can be rapidly generated, and the frame rate of the mobile terminal in displaying the stereoscopic image can be increased.

FIG. 2 shows the flow chart of steps of the method for stereoscopic image display processing in an embodiment of the present disclosure, specifically including:

step 201, establishing the first thread and the second thread on the basis of an image rendering instruction when the image rendering instruction is detected.

Specifically, when the VR system based on the mobile phone needs to render the image frame of the scene, the mobile phone can automatically generate the image rendering instruction, and can also generate the image rendering instruction on the basis of operation of a user, which is not restricted by the embodiment of the present disclosure.

When the image rendering instruction is detected, the VR system based on the mobile phone can process the image rendering instruction, that is, the first thread and the second thread are established on the basis of the image rendering instruction, for example, the first thread and the second thread are established by calling a preset interface on the basis of the image rendering instruction, wherein the first thread can be used for generating the rendered image and the second thread can be used for drawing the rendered image.

Step 203, rendering the data frame of the first scene by the first thread to generate the rendered image of the first scene.

Step 205, rendering the data frame of the current scene by the first thread from the second scene, and simultaneously drawing the rendered image of the former scene by the second thread to generate stereoscopic image data corresponding to the former scene.

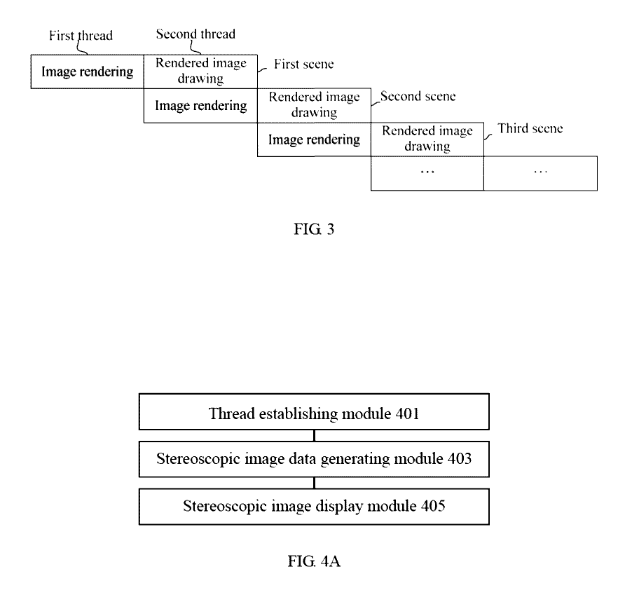

In the process of image rendering, as shown in FIG. 3, the VR system based on the mobile phone can separate image rendering and counter-distortion and reverse dispersion calculation to two independent threads, and by implementing the first thread and the second thread concurrently, the stereoscopic image can be rapidly generated. Specifically, the data frame of the first scene is rendered by the first thread to generate the rendered image of the first scene. After rendering the data frame of the first scene, the first thread continuously renders the data frame of the second scene; at the same time, the second thread draws the rendered image of the first scene, for example, implements counter-distortion and reverse dispersion calculation on the rendered image of the first scene to generate the stereoscopic image corresponding to the first scene. After rendering the data frame of the second scene, the first thread continuously renders a data frame of a third scene, . . . and so on till data frames of all scenes are rendered. In a similar way, after drawing the rendered image of the first scene, the second thread continuously draws the rendered image of the second scene, . . . and so on till stereoscopic images of all scenes are drawn.

In an optimal embodiment of the present disclosure, the step of rendering the data frame of the scene by the first thread includes the following sub-steps.

Sub-step 20511, acquiring two data frames of the scene.

Specifically, the VR system based on the mobile phone generally displays image frames with certain aberration, of one same scene on left and right sub-screens of the display screen of the mobile phone, then the user can watch left and right eye images displayed on a same screen with special glasses, and thus stereoscopic image can be formed. Therefore, in the image rendering process, the first thread can acquire two data frames of one same scene, one of the two data frames is a first data frame, and the other one is a second data frame. When the frame number of one data frame is an odd number, the data frame can be confirmed as the first data frame, for example, a data frame with the frame number of 1 or 3 is confirmed as the first data frame. When the frame number of one data frame is an even number, the data frame can be confirmed as the second data frame, for example, a data frame with the frame number of 2 or 4 is confirmed as the second data frame. When the data frame is the first data frame, a sub-step 2013 is implemented; when the data frame is the second data frame, a sub-step 20515 is implemented.

Sub-step 20513, implementing off-screen rendering on the first data frame to generate a first rendered image.

Sub-step 20515, implementing off-screen rendering on the second data frame to generate a second rendered image.

Specifically, the VR system based on the mobile phone can divide generated rendered images into the first rendered image and the second rendered image in the image rendering process, wherein the first rendered image can be a rendered image generated by rendering the first data frame, and the second rendered image can be a rendered image generated by rendering the second data frame. The VR system can display the first rendered image as a right eye image and the second rendered image as a left eye image; of course the first rendered image can be displayed as the left eye image and the second rendered image as the right eye image, which is not restricted in the embodiment of the present disclosure. The situation that the first rendered image is displayed as the left eye image and the second rendered image as the right eye image is taken as an example to describe the embodiment of the present disclosure, which is not restricted of the embodiment of the present disclosure.

Optionally, the VR system based on the mobile phone can also store the first generated rendered image in a first off-screen buffer and store the second generated rendered image in a second off-screen buffer.

In the embodiment of the present disclosure, after the data frame is rendered by the first thread, the generated rendered image can be stored in a buffer in display card cache such as an off-screen buffer. Specifically, the first data frame is rendered by the first thread into one frame buffer, equivalently, the first rendered image is generated, and the first rendered image is stored in the first off-screen buffer, that is, the first rendered image generated by the first thread is placed in an off-screen buffer corresponding to the left eye. In a same way, the second data frame is rendered by the first thread to generate the second rendered image, and the second rendered image is stored in the second off-screen buffer, that is, the second rendered image generated by the second thread is placed in an off-screen buffer corresponding to the right eye.

In an optimal embodiment of the present disclosure, the step of drawing the rendered image of the scene by the second thread to generate stereoscopic image data corresponding to the scene specifically includes the following sub-steps.

Sub-step 20521, acquiring the first rendered image from the first off-screen buffer and acquiring the second rendered image from the second off-screen buffer.

After the data frame is rendered by the first thread, the generated rendered image is stored in a corresponding off-screen buffer, that is, the first rendered image is stored in the first off-screen buffer and the second rendered image is stored in the second off-screen buffer. When the rendered image of the scene is drawn, the first rendered image of the drawn scene can be acquired from the first off-screen buffer by the second thread, and the second rendered image of the drawn scene can be also acquired from the first off-screen buffer.

Sub-step 20521, calling a preset algorithm to implement counter-distortion and reverse dispersion calculation on the first rendered image and the second rendered image to generate the stereoscopic image data.

In practice, the second thread can call the algorithm such as a counter-distortion and reverse dispersion algorithm preset by the VR system to implement counter-distortion and reverse dispersion calculation on the first rendered image and the second rendered image, that is, the rendered images of scenes are drawn by using VR system parameters such as lens optical parameters, distance of left and right lenses, distance of screens and lenses and distance of lenses and eyes, so as to generate the stereoscopic image data corresponding to drawn scenes.

Optionally, the stereoscopic image data include left-screen displayed data and right-screen displayed data. The sub-step 20521 can specifically include calling the algorithm to implement counter-distortion and reverse dispersion calculation on the first rendered image to generate the left-screen displayed data, and calling the algorithm to implement counter-distortion and reverse dispersion calculation on the second rendered image to generate the right-screen displayed data.

Specifically, when being the first rendered image, the rendered image is subjected to the counter-distortion and reverse dispersion calculation by the second thread to generate the left-screen displayed data. When being the second rendered image, the rendered image is subjected to counter-distortion and reverse dispersion calculation by the second thread to generate the right-screen displayed data.

Step 207, playing the stereoscopic image data to display corresponding stereoscopic image data.

In the VR system based on the mobile phone, by playing the stereoscopic image data, that is, displaying the left-screen displayed data and the right-screen displayed data generated by the second threaded on the display screen, stereoscopic images corresponding to various scenes can be generated.

In the embodiment of the present disclosure, the VR system based on the mobile phone can separate image rendering and counter-distortion and reverse dispersion calculation into two independent threads, and the time for generating the stereoscopic image data can be shortened when the first thread and the second thread are concurrently implemented, so that the frame rate of the mobile terminal in displaying the stereoscopic images can be increased, furthermore the high-delay phenomenon caused by overall one-time rendering can be reduced, the problem that the user feels dizzy because of rendered image delay can be solved, and the user experience can be improved.

What needs to be explained is that to be described concisely, the method in the embodiments is expressed as a combination of a series of action, however a person skilled in the art shall understand that the embodiment of the present disclosure is not restricted by the sequence of the described action as some steps can be implemented in other sequences or simultaneously in the embodiments of the present disclosure. Secondly, the person skilled in the art shall also understand that the embodiments in the present disclosure are all optimal embodiments, and action involved in the embodiments is not definitely essential in the embodiments of the present disclosure.

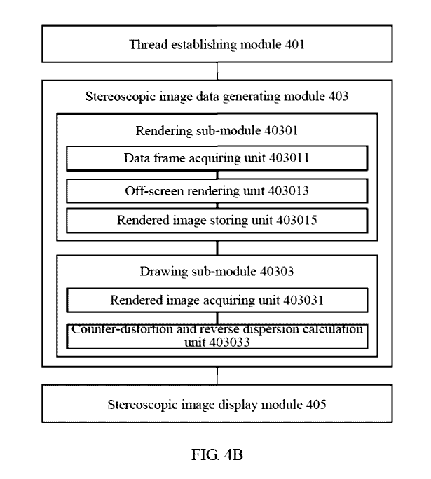

FIG. 4A shows the structure diagram of the device for stereoscopic image display processing in an embodiment of the present disclosure, specifically including:

a thread establishing module 401, for establishing a first thread and a second thread:

a stereoscopic image data generating module 403, for synchronously executing the first thread and the second thread in image rendering process to generate stereoscopic image data corresponding to scenes;

wherein the first thread can be used for generating a rendered image and the second thread can be used for drawing the rendered image.

a stereoscopic image display module 405, for playing the stereoscopic image data to display corresponding stereoscopic image data.

In one optimal embodiment of the present disclosure, the thread establishing module 401 can be specifically used for establishing the first thread and the second thread on the basis of an image rendering instruction when the image rendering instruction is detected.

On the basis of FIG. 4A, optionally, the stereoscopic image data generating module 403 can include a rendering sub-module 40301 and a drawing sub-module 40303, as shown in FIG. 4B.

The rendering sub-module 40301 can be used for triggering the first thread to render a data frame of a scene to generate a rendered image of the scene.

In one optimal embodiment of the present disclosure, the rendering sub-module 40301 can include the following units:

a data frame acquiring unit 403011, for acquiring two data frames of a scene;

an off-screen rendering unit 403013, for implementing off-screen rendering on a first data frame to generate a first rendered image when the data frame is the first data frame, and further for implementing off-screen rendering on a second data frame to generate a second rendered image when the data frame is the second data frame;

a rendered image storing unit 403015 for storing the first generated rendered image in a first off-screen buffer, and storing the second generated rendered image in a second off-screen buffer.

The drawing sub-module 40303 can be used for triggering the second thread to draw the rendered image of the scene to generate stereoscopic image data corresponding to the scene.

Optionally, the drawing sub-module 40303 can include the following units:

a rendered image acquiring unit 403031 for acquiring a first rendered image from the first off-screen buffer, and acquiring a second rendered image from the second off-screen buffer:

a counter-distortion and reverse dispersion calculation unit 403033 for calling a preset algorithm to implement counter-distortion and reverse dispersion calculation on the first rendered image and the second rendered image to generate the stereoscopic image data.

In one optional embodiment of the present disclosure, the stereoscopic image data can include left-screen displayed data and right-screen displayed data. The counter-distortion and reverse dispersion calculation unit 403033 can be specifically used for calling the algorithm to implement counter-distortion and reverse dispersion calculation on the first rendered image to generate the left-screen displayed data, and used for implementing counter-distortion and reverse dispersion calculation on the second rendered image to generate the and right-screen displayed data.

As the device of the embodiments is generally similar to the method of the embodiments, the device is relatively concisely described, see related parts in description of the method of the embodiments.

The embodiments of the present disclosure are all described in a progressive mode, differences of the embodiments from those of others are particularly described, and refer to one another about similar parts of the embodiments.

A person skilled in the art shall understand that the embodiments of the present disclosure can be provided in manners of methods, devices or computer program products. Therefore, the embodiments of the present disclosure can be complete hardware embodiments, complete software embodiments or embodiments with the combination of software and hardware. Moreover the embodiments of the present disclosure can be computer program products which are implemented in one or more computer available storage mediums (including but not limited to a disc memory, a CD-ROM, an optimal memory and the like) with computer available program codes.

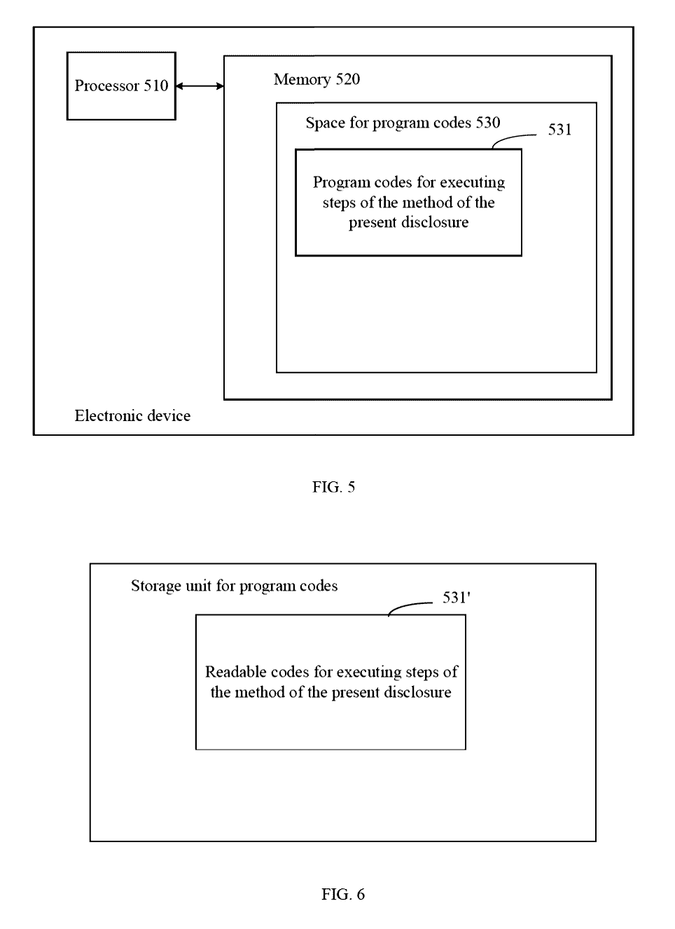

For example, FIG. 5 illustrates a block diagram of an electronic device for executing the method according the disclosure. The electronic device may be the mobile terminal above. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

The embodiments of the present disclosure are described referring to the flow charts and/or block diagrams of the methods, terminal equipment (system) and computer program products of the embodiments of the present disclosure. Do understand that each procedure and/or block in the flow charts and/or block diagrams and combinations of procedures and/or blocks in the flow charts and/or the block diagrams can be realized by using computer program instructions. The computer program instructions can be provided into a processor of a general-purpose computer, a special computer, a built-in processor or other programmable data processing terminal equipment so as to generate a machine which enables instructions implemented by the processor of the computer or other programmable data processing terminal equipment to generate a device for realizing functions appointed in one procedure or multiple procedures in the flow charts and/or one block or multiple blocks in the block diagrams.

The computer program instructions can be also stored in a computer readable memory capable of instructing the computer or other programmable data processing terminal equipment to work in a specific mode, so as to enable instructions stored in the computer readable memory to generate a product including an instruction device for realizing appointed functions in one procedure or multiple procedures of the flow charts and/or one block or multiple blocks of the block diagrams.

The computer program instructions can be also loaded to the computer or other programmable data processing terminal equipment, so that a series of operation steps can be implemented in the computer or other programmable data processing terminal equipment so as to generate processing realized by the computer, then the instructions implemented in the computer or other programmable data processing terminal equipment are used for providing steps for realizing appointed functions in one procedure or multiple procedures of the flow charts and/or one block or multiple blocks of the block diagrams.

Although optimal ones of the embodiments of the present disclosure are described, a person skilled in the art can make additional change and modification to the embodiments once learning basic creative concepts, therefore, claims as follows intend to be interpreted as including the optimal embodiments and all changes and modifications within the scope of the embodiments of the present disclosure.

The final description is that in the text, the relationship terms such as the first and the second are only used for distinguishing one entity or operation from another entity or operation but not requiring or hinting that the entity or operation has the actual relationship or sequence. In addition, the terms “comprise”, “include” or any other variant intend to cover nonexclusive inclusion, so that procedures, methods, products or devices including a series of elements not only include the elements, but also other elements which are not specifically listed, or include inherent elements of the procedures, the methods, the products or the devices. Under the condition of no more limit, elements defined in the sentence “include one . . . ” do not exclude that the procedures, the methods, the products or the devices including the elements also have other identical elements.

The method for stereoscopic image display processing and the device for stereoscopic image display processing, which are provided by the present disclosure, are specifically described, specific examples are taken to explain principles and modes of execution of the present disclosure in the text, and the description about the embodiments is only to promote understanding about the methods and the key concepts of the present disclosure; meanwhile a person skilled in the art can make change on specific modes of execution and application ranges on the basis of the concepts of the present disclosure, and to sum up, the content of the specification shall not be interpreted as restriction on the present disclosure.

What is claimed is:

1. A method for stereoscopic image display processing, at an electronic device, comprising:
establishing a first thread and a second thread;
synchronously implementing the first thread and the second thread in image rendering process to generate stereoscopic image data corresponding to scenes, wherein the first thread is used for generating a rendered image, and the second thread is used for drawing the rendered image;
playing the stereoscopic image data to display corresponding stereoscopic image data.

2. The method according to claim 1, before synchronously implementing the first thread and the second thread in the image rendering process to generate stereoscopic image data corresponding to the scenes, the method further comprising:
rendering a data frame of a first scene by the first thread to generate a rendered image of the first scene;
the step of synchronously implementing the first thread and the second thread in the image rendering process to generate stereoscopic image data corresponding to the scenes, further comprising:
rendering a data frame of a current scene by the first thread from a second scene, and simultaneously drawing a rendered image of a former scene by the second thread to generate stereoscopic image data corresponding to the former scene.

3. The method according to claim 1, wherein establishing the first thread and the second thread comprises:
establishing the first thread and the second thread on the basis of an image rendering instruction when the image rendering instruction is detected.

4. The method according to claim 2, wherein rendering the data frame of the scene by the first thread comprises:
acquiring two data frame of a scene;
when the data frame is a first data frame, implementing off-screen rendering on the first data frame to generate a first rendered image;
when the data frame is a second data frame, implementing off-screen rendering on the second data frame to generate a second rendered image.

5. The method according to claim 4, further comprising:
storing the first generated rendered image in a first off-screen buffer, and storing the second generated rendered image in a second off-screen buffer.

6. The method according to claim 5, wherein simultaneously drawing the rendered image of the scene by the second thread to generate stereoscopic image data corresponding to the former scene comprises:
acquiring a first rendered image from the first off-screen buffer, and acquiring a second rendered image from the second off-screen buffer;
calling a preset algorithm to implement counter-distortion and reverse dispersion calculation on the first rendered image and the second rendered image to generate the stereoscopic image data.

7. The method according to claim 6, wherein the stereoscopic image data comprise left-screen displayed data and right-screen displayed data:
the step of calling the preset algorithm to implement counter-distortion and reverse dispersion calculation on the first rendered image and the second rendered image to generate the stereoscopic image data comprises:
calling the algorithm to implement counter-distortion and reverse dispersion calculation on the first rendered image to generate the left-screen displayed data;
calling the algorithm to implement counter-distortion and reverse dispersion calculation on the second rendered image to generate the right-screen displayed data.

8. An electronic device for stereoscopic image display processing, comprising:
at least one processor; and
a memory communicably connected with the at least one processor for storing instructions executable by the at least one processor, wherein execution of the instructions by the at least one processor causes the at least one processor to:
establish a first thread and a second thread:
synchronously implement the first thread and the second thread in image rendering process to generate stereoscopic image data corresponding to scenes, wherein the first thread is used for generating a rendered image, and the second thread is used for drawing the rendered image;
play the stereoscopic image data to display corresponding stereoscopic image data.

9. The electronic device according to claim 8, wherein the step to synchronously implement the first thread and the second thread in image rendering process to generate stereoscopic image data corresponding to scenes comprises:
trigger the first thread to render a data frame of a scene to generate a rendered image of the scene;
trigger the second thread to draw the rendered image of the scene to generate stereoscopic image data corresponding to the scene.

10. The electronic device according to claim 8, wherein the step to establish a first thread and a second thread comprises: establish the first thread and the second thread on the basis of an image rendering instruction when the image rendering instruction is detected.

11. The electronic device according to claim 9, wherein the step to trigger the first thread to render a data frame of a scene to generate a rendered image of the scene comprises:
acquire two data frames of a scene;
implement off-screen rendering on a first data frame to generate a first rendered image when the data frame is the first data frame, and further for implement off-screen rendering on a second data frame to generate a second rendered image when the data frame is the second data frame.

12. The electronic device according to claim 11, wherein the step to trigger the first thread to render a data frame of a scene to generate a rendered image of the scene further comprises:
store the first generated rendered image in a first off-screen buffer, and store the second generated rendered image in a second off-screen buffer.

13. The electronic device according to claim 12, wherein the step to trigger the second thread to draw the rendered image of the scene to generate stereoscopic image data corresponding to the scene comprises:
acquire a first rendered image from the first off-screen buffer, and acquire a second rendered image from the second off-screen buffer;
call a preset algorithm to implement counter-distortion and reverse dispersion calculation on the first rendered image and the second rendered image to generate the stereoscopic image data.

14. The electronic device according to claim 13, wherein the stereoscopic image data comprise left-screen displayed data and right-screen displayed data;
the step to call a preset algorithm to implement counter-distortion and reverse dispersion calculation on the first rendered image and the second rendered image to generate the stereoscopic image data comprises: call the algorithm to implement counter-distortion and reverse dispersion calculation on the first rendered image to generate the left-screen displayed data, and used for implementing counter-distortion and reverse dispersion calculation on the second rendered image to generate the right-screen displayed data.

15. A non-transitory computer readable medium storing executable instructions that, when executed by an electronic device, cause the electronic device to:
establish a first thread and a second thread;
synchronously implement the first thread and the second thread in image rendering process to generate stereoscopic image data corresponding to scenes, wherein the first thread is used for generating a rendered image, and the second thread is used for drawing the rendered image;
play the stereoscopic image data to display corresponding stereoscopic image data.

16. The non-transitory computer readable medium according to claim 15, wherein the step to synchronously implement the first thread and the second thread in image rendering process to generate stereoscopic image data corresponding to scenes comprises:
trigger the first thread to render a data frame of a scene to generate a rendered image of the scene;
trigger the second thread to draw the rendered image of the scene to generate stereoscopic image data corresponding to the scene.

17. The non-transitory computer readable medium according to claim 15, wherein the step to establish a first thread and a second thread comprises: establish the first thread and the second thread on the basis of an image rendering instruction when the image rendering instruction is detected.

18. The non-transitory computer readable medium according to claim 16, wherein the step to trigger the first thread to render a data frame of a scene to generate a rendered image of the scene comprises:
acquire two data frames of a scene;
implement off-screen rendering on a first data frame to generate a first rendered image when the data frame is the first data frame, and further for implement off-screen rendering on a second data frame to generate a second rendered image when the data frame is the second data frame.

19. The non-transitory computer readable medium according to claim 18, wherein the step to trigger the first thread to render a data frame of a scene to generate a rendered image of the scene further comprises:
store the first generated rendered image in a first off-screen buffer, and store the second generated rendered image in a second off-screen buffer.

20. The non-transitory computer readable medium according to claim 19, wherein the step to trigger the second thread to draw the rendered image of the scene to generate stereoscopic image data corresponding to the scene comprises:
acquire a first rendered image from the first off-screen buffer, and acquire a second rendered image from the second off-screen buffer;
call a preset algorithm to implement counter-distortion and reverse dispersion calculation on the first rendered image and the second rendered image to generate the stereoscopic image data.
